(19) United States
(12) Patent Application Publication
(10) Pub. No.: US 2023/0257002 A1
(43) Pub. Date: Aug. 17, 2023

(54) METHOD AND CONTROLLER FOR CONTROLLING A MOTOR VEHICLE

(71) Applicant: ZF FRIEDRICHSHAFEN AG, Friedrichshafen (DE)

(72) Inventors: Till NATTERMANN, Krefeld (DE); Anne STOCKEM NOVO, Gladbeck (DE); Martin KRÜGER, Lossatal (DE)

(21) Appl. No.: 18/014,528

(22) PCT Filed: Jun. 17, 2021
(86) PCT No.: PCT/EP2021/066487

§ 371 Date: Jan. 5, 2023

(30) Foreign Application Priority Data
Jun. 7, 2020 (DE) 10 2020 208 421.1

(51) Int. Cl. B60W 60/00; G06V 20/58; G06V 20/56

(52) U.S. Cl. CPC B60W 60/0027; G06V 20/58; G06V 20/588; B60W 2554/4042

(57) ABSTRACT

A method for controlling a motor vehicle driving on a road in a current lane is described. Environmental data are determined by means of a sensor. At least one utility value functional is determined based on the environmental data, wherein the utility value functional assigns a utility value for the at least one other road user at a predefined point in time in each case for different spatial areas of the current lane and/or the at least one other lane. A two-dimensional representation of the at least one utility functional is determined. At least one probable trajectory of the at least one other road user is determined based on the two-dimensional representation of the utility value functional by applying pattern recognition to the two-dimensional representation. A control unit, a motor vehicle and a computer program are also described.

### TECHNICAL FIELD

The invention relates to a method for controlling a motor vehicle. The invention furthermore relates to a control unit for a system for controlling a motor vehicle, a motor vehicle, and a computer program.

### BACKGROUND

One of the tasks of driver assistance systems, which control a longitudinal movement and a lateral movement of a motor vehicle in a partially automated manner, and above all for fully automated motor vehicles, is to analyze a specific situation in which the motor vehicle is located and, based on this, to determine and execute in real time appropriate reasonable driving maneuvers for the vehicle.

The complexity of the computation of the driving maneuvers generally increases with the duration of the individual driving maneuvers. If different, possible driving maneuvers are to be determined for a longer period of time, for example longer than three seconds, or these are complex driving maneuvers having several lane changes, previously known methods are often no longer capable of determining them in real time.

This is particularly the case when other road users are on the road, because in this case it also has to be taken into consideration that the other road users may change lanes, brake, accelerate, etc.

### SUMMARY

The object of the invention is therefore to provide a method and a control unit for controlling a motor vehicle that predicts possible driving maneuvers by other road users.

The object is achieved according to the invention by a method for controlling a motor vehicle which is driving on a road in a current lane, wherein the motor vehicle has at least one sensor which is designed to acquire at least one area of the current lane in front of the motor vehicle, and wherein at least one other road user is on the current lane and/or on at least one other lane. The method comprises the following steps:
acquiring environmental data by means of the at least one sensor, wherein the environmental data comprise items of information about properties of the current lane, about properties of the at least one other lane, and/or about the at least one other road user;
determining at least one utility value functional based on the environmental data, wherein the utility value functional assigns a utility value for the at least one other road user add a predefined point in time in each case for different spatial areas of the current lane and/or the at least one other lane;
determining a two-dimensional representation of the at least one utility value functional; and
determining at least one probable trajectory of the at least one other road user based on the two-dimensional representation of the utility value functional by applying pattern recognition to the two-dimensional representation.

The utility value represents a cost-benefit analysis for the at least one other road user to go to the corresponding area.

A high utility value corresponds to high costs or a low benefit, while a low utility value corresponds to low costs or a high benefit.

The utility value is increased, for example, if traffic rules have to be broken in order to reach the corresponding area. Furthermore, the utility value is increased if predefined longitudinal and/or lateral distances to other road users are undershot, high accelerations are necessary, etc.

The utility value is reduced, for example, if the corresponding area of the road enables the destination to be reached quickly, collisions are safely avoided, the corresponding driving maneuver only requires minor accelerations, etc.

The two-dimensional representation is a representation of the traffic situation in surroundings of the motor vehicle at a specific point in time. Accordingly, the two-dimensional representation has two spatial axes, in particular wherein one of the spatial axes corresponds to a direction of travel of the motor vehicle and wherein the other of the spatial axes corresponds to a transverse direction.

The method according to the invention is based on the basic concept of not computing the probable trajectory of the at least one other road user directly from the utility value functional using a conventional algorithm, but instead determining the two-dimensional representation of the utility value functional and applying pattern recognition to the two-dimensional representation. The probable trajectory is then determined based on this pattern recognition.

In this way, a natural driving style of humans is imitated, which is based less on a direct calculation of all relevant parameters than on an experience-based cost-benefit assessment.

The probable trajectory can be a family of trajectories. In other words, different possible trajectories together with their respective probability can be determined for the at least one other road user.

One aspect of the invention provides that a two-dimensional representation of the corresponding utility value functional is determined at each of multiple predefined points in time, in particular in the past, and wherein the at least one probable trajectory of the at least one other road user is determined based on the two-dimensional representations by applying pattern recognition to the two-dimensional representations.

The set of two-dimensional representations at different points in time represents the progress of the traffic situation over time over an observation period. In other words, multiple utility value functionals and their respective two-dimensional representations are determined for the observation period, each of which represents a fixed point in time. The data from the observation period are then used to predict the future trajectory of the at least one other road user.

The observation period can be between one second and five seconds, for example, in particular between two and three seconds.

According to a further aspect of the invention, a three-dimensional tensor is determined based on the two-dimensional representations, the at least one probable trajectory of the at least one other road user being determined based on the tensor by applying pattern recognition to the tensor. In other words, the data available from the observation period are summarized in a single three-dimensional tensor, so that all data from the observation period can be used for the pattern recognition.

Preferably, the two-dimensional representations are stacked on one another along the time dimension to determine the tensor. The three-dimensional tensor thus has two dimensions, which correspond to the spatial dimensions of the road, and a temporal dimension.

In one embodiment of the invention, the different spatial areas are represented as grid points. In other words, the road is divided into a two-dimensional grid, wherein the individual grid points of the grid each represent an area of the road.

The utility value functional assigns the corresponding utility value for the at least one other road user to each of the grid points.

The pattern recognition is preferably carried out by means of an artificial neural network, in particular by means of a convolutional neural network. Artificial neural networks, in particular convolutional neural networks, are particularly well suited for pattern recognition in multidimensional structures.

A further aspect of the invention provides that the artificial neural network has two-dimensional and/or three-dimensional filter kernels and/or that the artificial neural network has two-dimensional or three-dimensional pooling layers.

In particular, the artificial neural network has two-dimensional filter kernels and two-dimensional pooling layers. All time strips of the three-dimensional tensor are processed here simultaneously by means of the two-dimensional filter kernel, wherein a depth of the filter kernel in the time direction corresponds to a number of input channels. The number of input channels is equal to the number of time strips of the three-dimensional tensor here, i.e., equal to the number of two-dimensional representations in the observation period. It has been found that the artificial neural network in this embodiment of the invention can be trained more easily and faster and that a smaller amount of data has to be stored.

For example, the artificial neural network includes three-dimensional filter kernels and three-dimensional pooling layers. Accordingly, here only a predefined number of time strips of the three-dimensional tensor are processed simultaneously by means of the three-dimensional filter kernel. Accordingly, the depth of the filter kernels in the time direction is also less here than the number of time strips of the three-dimensional tensor. In addition to the shift along the spatial dimensions, the filter kernels are also shifted along the time dimension, so that pattern recognition also takes place along the time dimension. It has been found that although the artificial neural network is more difficult to train in this embodiment of the invention, the accuracy of the probable trajectory of the at least one other road user is significantly improved.

The artificial neural network is furthermore preferably trained using a training data set before it is used in the motor vehicle. On the one hand, this offers the advantage that the same training data set can be used for each motor vehicle, so that not every motor vehicle first has to be trained when it is in use. On the other hand, this offers the advantage that the time-consuming and computationally intensive training of the artificial neural network can be carried out centrally on a computer or computer network equipped accordingly with computing resources.

According to one embodiment of the invention, the two-dimensional representation is a two-dimensional image, in particular wherein a color of the individual pixels is determined based on the value of the corresponding utility value. In other words, the current traffic situation is thus translated into one or more images. The prognosis of the probable trajectory of the at least one other road user is then based on the pattern recognition that is applied to the image or images.

For example, the value of the utility value in the two-dimensional representation is encoded in shades of gray, in particular at the corresponding grid points. Alternatively, however, any other suitable color scheme can also be used.

A higher value of the utility value can correspond to a darker pixel in the two-dimensional representation and a lower utility value to a lighter pixel in the two-dimensional representation.

Alternatively, of course, a higher value of the utility value can also correspond to a lighter pixel and a lower utility value to a darker pixel in the two-dimensional representation.

According to a further embodiment of the invention, other road users who are spatially within a predefined distance from one another are regarded as a group of other road users, wherein a common utility value functional is determined for the group of other road users. This saves computing time, since a separate utility value functional or a separate tensor does not have to be determined for each additional road user.

For example, a separate probable trajectory is computed for each of the other road users.

A further aspect of the invention provides that, in particular for each other road user in the group, a previous trajectory of the at least one other road user is determined, wherein the at least one probable trajectory of the at least one other road user is determined on the basis of the determined previous trajectory, in particular wherein the result of the pattern recognition and the previous trajectory are supplied to an artificial neural network which determines the at least one probable trajectory.

In other words, the probable trajectory of the at least one other road user is determined based on a combination of pattern recognition and observation of the previous trajectory, in particular by means of another artificial neural network, the input data of which are the result of the pattern recognition and the determined previous trajectory.

In particular, the previous trajectory is determined using a trajectory detection module. The probable trajectory can be produced by means of a trajectory determination module.

It is to be noted that the structure and functioning of the trajectory detection module and the trajectory determination module per se are already known from the publication “Convolutional Social Pooling for Vehicle Trajectory Prediction” by N.Deo and MM Trivedi, arXiv:1805.06771, which was presented at the IEEE CVPR Workshop 2018.

According to the invention, however, these modules are combined with pattern recognition, which recognizes patterns in the two-dimensional representations or in the three-dimensional tensor.

The items of information about the properties of the current lane and/or about the properties of the at least one other lane can comprise at least one of the following elements: location and/or course of roadway markings, type of roadway markings, location and/or type of traffic signs, location and/or course of guide rails, location and/or switching status of at least one traffic light, location of at least one parked vehicle.

For example, the items of information about the at least one other road user comprise a location of the at least one other road user, a speed of the at least one other road user, and/or an acceleration of the at least one other road user.

One aspect of the invention provides that the at least one probable trajectory is transferred to a driving maneuver planning module of the motor vehicle. Expressed in general terms, the driving maneuver planning module determines a driving maneuver to be carried out by the motor vehicle based on the at least one probable trajectory and based on the environmental data. In this case, an interaction of the motor vehicle with the other road users via the probable trajectories of the other road users is taken into consideration. The driving maneuver to be carried out is then transferred to a trajectory planning module of the motor vehicle. Based on the received driving maneuver, the trajectory planning module determines the specific trajectory that the motor vehicle is to follow.

The motor vehicle can then be controlled automatically at least partially, in particular completely, based on the determined trajectory.

In particular, at least the current lane will be and/or the at least one other lane is/are transformed into a Frenet-Serret coordinate system. In this coordinate system, every road is free of curvature, so that every road traffic situation can be handled in the same way, independently of the actual course of the road.

The object is also achieved according to the invention by a control unit for a system for controlling a motor vehicle or for a motor vehicle, wherein the control unit is designed to carry out the above-described method.

With regard to the advantages and properties of the control unit, reference is made to the above explanations regarding the method, which also apply to the control unit and vice versa.

The object is also achieved according to the invention by a motor vehicle having an above-described control unit.

With regard to the advantages and properties of the motor vehicle, reference is made to the above explanations regarding the method, which also apply to the motor vehicle and vice versa.

The object is also achieved according to the invention by a computer program having program code means to carry out the steps of an above-described method when the computer program is executed on a computer or a corresponding computing unit, in particular a computing unit of an above-described control unit.

With regard to the advantages and properties of the computer program, reference is made to the above explanations regarding the method, which also apply to the computer program and vice versa.

“Program code means” here and below are to be understood as computer-executable instructions in the form of program code and/or program code modules in compiled and/or in uncompiled form, which can be provided in any programming language and/or in machine language.

### BRIEF DESCRIPTION OF THE DRAWINGS

Further advantages and properties of the invention result from the following description and the accompanying drawings, to which reference is made. In the figures:

FIG. 1 schematically shows a road traffic situation;

FIG. 2 shows a schematic block diagram of a system for controlling a motor vehicle by means of a method according to the invention;

FIG. 3 shows a flow chart of the steps of a method according to the invention;

FIGS. 4(a) and 4(b) schematically show a road before transformation into a Frenet-Serret coordinate system and the road after transformation into a Frenet-Serret coordinate system;

FIG. 5 shows exemplary plots of utility value functionals;

FIG. 6 schematically shows a stack of two-dimensional representations of one of the utility value functionals from FIG. 5 at different points in time;

FIG. 7 shows a schematic block diagram of a computer program for carrying out the method according to the invention;

FIG. 8 schematically shows a first possible architecture of an artificial neural network of the computer program of FIG. 7;

FIG. 9 schematically shows a second possible architecture of an artificial neural network of the computer program of FIG. 7; and

FIG. 10 schematically shows an alternative architecture of the computer program of FIG. 7.

### DESCRIPTION

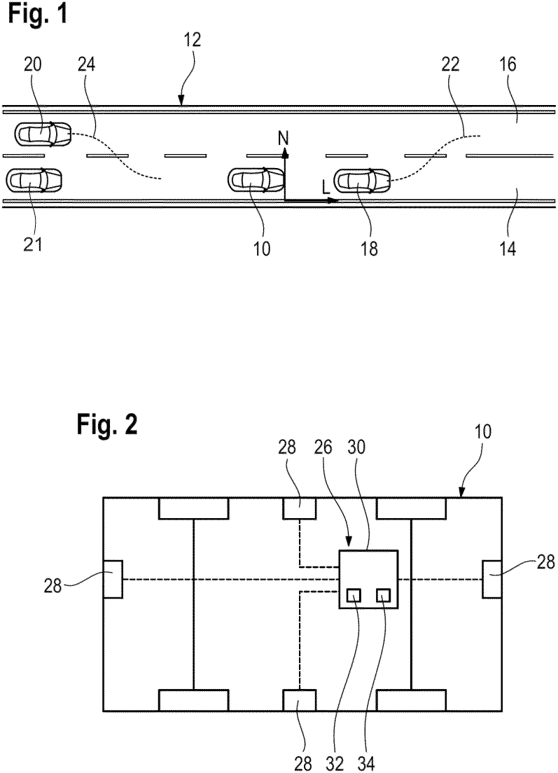

A road traffic situation is schematically shown in FIG. 1, in which a motor vehicle 10 is driving on a road 12 in a current lane 14. Next to the current lane 14, another lane 16 extends.

A first other road user 18, a second other road user 20, and a third other road user 21 are additionally driving on the road 12 in the current lane 14 or in the other lane 16. In the example shown, the other road users 18, 20, 21 are passenger vehicles, but they could also be trucks, motorcycles, or any other road user.

The dashed lines 22 and 24 indicate that the first other road user 18 is planning in the near future to change from the current lane 14 to the other lane 16 or that the second other road user 20 is planning in the near future to change from the other lane 16 to the current lane 14 of the motor vehicle 10. This is indicated by the other road users 18, 20, for example, by using the corresponding direction indicator.

In addition, FIG. 1 shows a coordinate system having a longitudinal axis and a normal axis, wherein the longitudinal axis defines a longitudinal direction L and wherein the normal axis defines a transverse direction N. The origin of the coordinate system is in the longitudinal direction L at the current position of the front of the motor vehicle 10 and, seen in the longitudinal direction L, on the right edge of the road.

This special coordinate system, which is also used below, is a road-fixed coordinate system, which consequently does not move with motor vehicle 10. Of course, any other coordinate system can also be used.

As shown in FIG. 2, the motor vehicle 10 has a system 26 for controlling the motor vehicle 10. The system 26 comprises multiple sensors 28 and at least one control unit 30.

The sensors 28 are arranged on the front, rear, and/or side of the motor vehicle 10 and are designed to detect the surroundings of the motor vehicle 10, to generate corresponding environmental data, and to pass on these data to the control unit 30. More precisely, the sensors 28 acquire items of information at least about the current lane 14, the other lane 16, and the other road users 18, 20, 21.

The sensors 28 are respectively a camera, a radar sensor, a distance sensor, a LIDAR sensor, and/or any other type of sensor that is suitable for acquiring the surroundings of the motor vehicle 10.

Alternatively or additionally, at least one of sensors 28 can be designed as an interface to a control system that is assigned to at least the section of the road 12 shown and is designed to transmit environmental data about the road 12 and/or about the other road users 18, 20, 21 to the motor vehicle 10 and/or to the other road users 18, 20, 21. In this case, one of the sensors 28 can be designed as a mobile radio communication module, for example for communication according to the 5G standard.

Expressed in general terms, the control unit 30 processes the environmental data received from the sensors 28 and controls the motor vehicle 10 based on the processed environmental data in an at least partially automated manner, in particular fully automatically. A driver assistance system is therefore implemented on the control unit 30, which can control a transverse movement and/or a longitudinal movement of the motor vehicle 10 in an at least partially automated manner, in particular fully automatically.

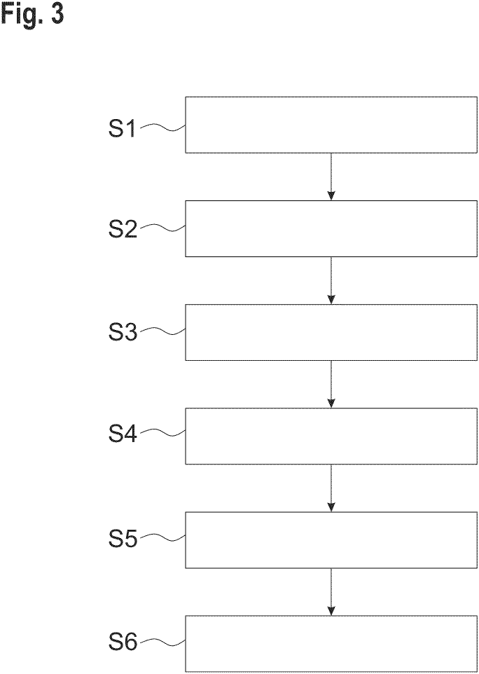

For this purpose, the control unit control unit 30 is designed to carry out the method steps explained below with reference to FIGS. 3 to 10.

More precisely, the control unit 30 comprises a data carrier 32 and a computing unit 34, wherein a computer program is stored on the data carrier 32, which is executed on the computing unit 34 and comprises program code means to carry out the steps of the method explained hereinafter.

First, environmental data are acquired by means of the sensors 28 (step S1).

Expressed in general terms, the environmental data comprise all items of information about the surroundings of the motor vehicle 10 that are important for the automated control of the motor vehicle 10.

More precisely, the environmental data comprise items of information about the properties of the current lane 14 and the properties of the other lane 16 as well as items of information about the other road users 18, 20, 21.

The items of information about the properties of the current lane 14 and the properties of the other lane 16 comprise one or more of the following elements: location and/or course of roadway markings, type of roadway markings, location and/or type of traffic signs, location and/or course of guide rails, location and/or switching status of at least one traffic light, location of at least one parked vehicle.

Furthermore, the items of information about the other road users 18, 20, 21 comprise a respective location of the other road users 18, 20, 21, a respective speed of the other road users 18, 20, 21, and/or a respective acceleration of the other road users 18, 20, 21.

It is also conceivable that the items of information about the other road users 18, 20, 21 comprise a type of the respective other road user 18, 20, 21, for example whether it is an automobile, a truck, a cyclist, or a pedestrian.

The road 12, more precisely an image of the current lane 14 and the further lane 16 based on the environmental data received from the sensors 28, is transformed into a Frenet-Serret coordinate system (step S2).

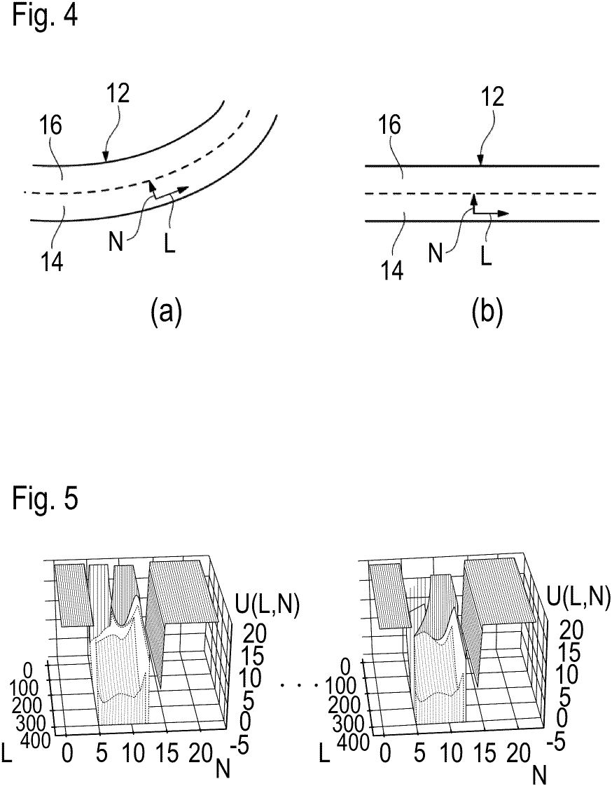

Step S2 is illustrated in FIG. 4. FIG. 4(a) shows the road 12 as it actually runs. In the example shown, the road, viewed in the longitudinal direction L, has a curvature to the left. A local coordinate transformation transforms the road 12 into the Frenet-Serret coordinate system, in which the road 12 no longer has any curvature, wherein the result of this transformation is shown in FIG. 4(b). As can be clearly seen, the road 12 runs straight and without curvature along the longitudinal direction L in this coordinate system.

Based on the determined environmental data, a utility value functional is determined, which assigns a utility value for the other road users 18, 20, 21 to various spatial areas of the road 12 at a predefined point in time (step S3).

More precisely, a common utility value functional is determined in each case for groups of other road users who are within a predefined distance from one another.

In the example of FIG. 1, the first other road user 18 is far away from the other two other road users 20, 21. Therefore, a separate utility value functional is determined for the first other road user.

The second and third other road users 20, 21, however, are close together. A common utility value functional is therefore determined for the second and third additional road users 20, 21.

The road 12 is divided into a two-dimensional grid in order to determine the utility value function, wherein the individual grid points of the grid each represent an area of the road 12.

The utility value functionals assign the corresponding utility value for the first other road user 18 or for the group of second and third other road users 20, 21 to each of the grid points.

The respective utility value at the individual grid points represents a cost-benefit analysis for the first other road user 18 or for the group of second and third other road users 20, 21 to go to the corresponding area.

A high utility value corresponds to high costs or a low benefit, while a low utility value corresponds to low costs or a high benefit.

The utility value is increased, for example, if traffic rules have to be broken in order to reach the corresponding area. Furthermore, the utility value is increased if predefined longitudinal and/or lateral distances to other road users are undershot, high accelerations are necessary, etc.

The utility value is reduced, for example, if the corresponding area of the road enables the destination to be reached quickly, collisions are safely avoided, the corresponding driving maneuver only requires minor accelerations, etc.

The result of step S3 is illustrated in FIG. 5, in which two exemplary plots of utility value functionals are shown.

As shown in FIG. 5, the utility value functional is a function U of the longitudinal coordinate L and the transverse coordinate N and assigns a utility value U(L,N) to the individual grid points with coordinates (L,N).

In particular, the utility value functional is a superposition of several utility value functions, each of which reflects one or more of the above-mentioned aspects.

For example, the utility value functional is defined according to the formula

$$U = {U}_{R E} + {U}_{L M} + {U}_{O V} + {U}_{D V} .$$

In this case, U_{RE} is a contribution of boundaries of the road 12 to the utility functional. In the example in FIG. 5, areas outside the road 12 receive a maximum utility value, i.e., high costs, since the other road users 18, 20, 21 would have to leave the road 12 in order to get there.

U_{LM} is a contribution of road markings and their types, of traffic signs and their types, and/or of traffic signals and their switching status.

U_{OV} is a contribution of other road users. This post reflects other road users blocking areas of the road. Furthermore, this contribution can also reflect the type of other road users 18, 20, 21 since, for example, a greater distance has to be maintained from vulnerable road users.

U_{DV} is a contribution from a desired speed to be reached.

As indicated by the three dots between the two plots of the utility value functionals shown in FIG. 5, the utility value functionals can be determined at a predefined frequency, so that a predefined number of utility value functionals is determined over a predefined observation period.

The predefined frequency can be between 5 and 20 Hz, for example, in particular 8 to 15 Hz, for example 10 Hz.

In other words, multiple utility value functionals are determined for the observation period, each of which is assigned to a fixed point in time.

The observation period can be between one second and five seconds, for example, in particular between two and three seconds. The observation period extends proceeding from a starting point in the past to the present.

A two-dimensional representation of the corresponding utility value functional is determined for each of the determined utility value functionals (step S4).

The two-dimensional representations are each a two-dimensional image, wherein a color of the individual pixels is determined based on the value of the corresponding utility value at the corresponding grid point.

In particular, the value of the utility value at the corresponding grid point is encoded in shades of gray. Alternatively, however, any other suitable color scheme can also be used.

A higher value of the utility value can correspond to a darker pixel in the two-dimensional representation and a lower utility value to a lighter pixel in the two-dimensional representation.

Alternatively, of course, a higher value of the utility value can also correspond to a lighter pixel and a lower utility value to a darker pixel in the two-dimensional representation.

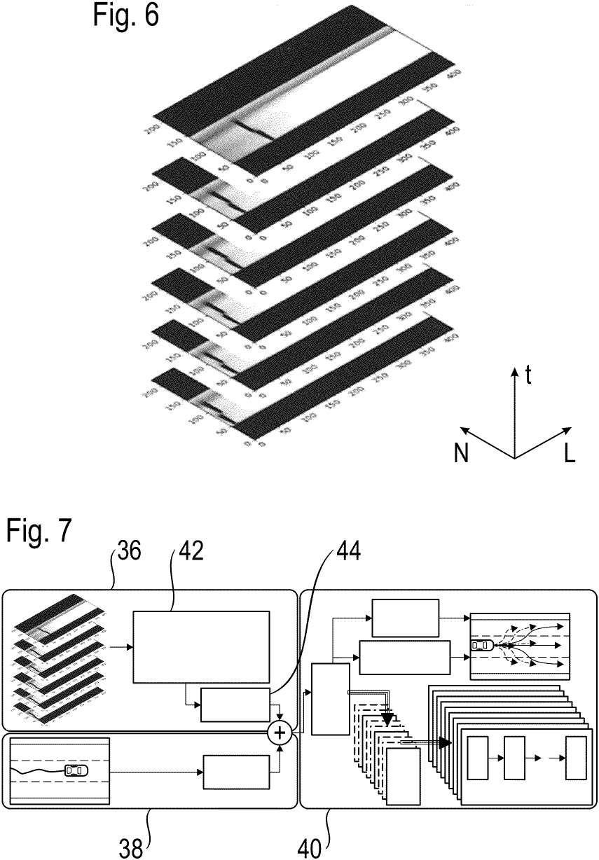

As illustrated in FIG. 6, a two-dimensional representation is determined for each of the utility value functionals that are determined at different times.

In other words, a two-dimensional representation is determined for each of multiple time strips in the observation period.

The determined two-dimensional representations are stacked on one another along the time direction so that a three-dimensional tensor is obtained (step S5).

Accordingly, in the three-dimensional tensor, each grid point (L,N) for each of the time strips is assigned a respective color value of the corresponding pixel.

Based on the three-dimensional tensor, a probable trajectory is determined for each of the other road users (step S6).

The sequence of step S6 is illustrated in FIG. 7, which schematically shows the structure of a corresponding computer program and its computer program modules.

The computer program comprises a pattern recognition module 36, a trajectory recognition module 38, and a trajectory determination module 40.

It is to be noted that the structure and functioning of the trajectory detection module 38 and the trajectory determination module 40 per se are already known from the publication “Convolutional Social Pooling for Vehicle Trajectory Prediction” by N.Deo and MM Trivedi, arXiv:1805.06771, which was presented at the IEEE CVPR Workshop 2018.

Accordingly, only the structure and the functionality of the pattern recognition module 36 are described in more detail hereinafter.

The pattern recognition module 36 has an artificial neural network 42 and a flattening layer 44.

The artificial neural network 42 is preferably designed as a convolutional neural network.

Expressed in general terms, the artificial neural network 42 receives the determined three-dimensional tensor as an input variable and generates an output variable by means of pattern recognition.

The output variable of the artificial neural network 42 differs depending on the architecture of the artificial neural network 42.

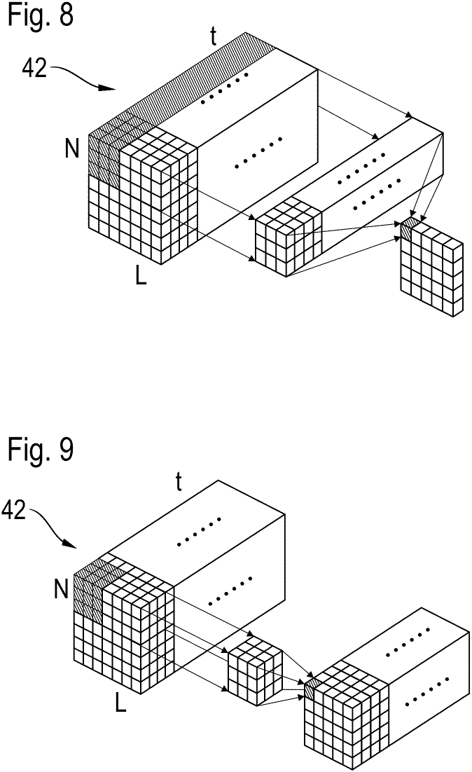

A first possible architecture of the artificial neural network is shown in FIG. 8.

The artificial neural network 42 has two-dimensional filter kernels and two-dimensional pooling layers here.

All time strips of the three-dimensional tensor are processed here simultaneously by means of the two-dimensional filter kernel, wherein a depth of the filter kernel in the time direction corresponds to a number of input channels. The number of input channels is equal here to the number of time strips of the three-dimensional tensor.

The output of the artificial neural network 42 is a two-dimensional matrix, which is converted into a vector by means of the flattening layer 44.

A first possible architecture of the artificial neural network is shown in FIG. 9.

The artificial neural network 42 includes three-dimensional filter kernels and three-dimensional pooling layers here.

Accordingly, here only a predefined number of time strips of the three-dimensional tensor are processed simultaneously by means of the three-dimensional filter kernel. Accordingly, the depth of the filter kernels in the time direction is also less here than the number of time strips of the three-dimensional tensor.

In addition to the shift along the spatial dimensions, the filter kernels are also shifted along the time dimension here, so that pattern recognition also takes place along the time dimension.

The output variable of the artificial neural network 42 is a three-dimensional output tensor here, which is converted into a vector by means of the flattening layer 44.

The three-dimensional output tensor can be converted directly into the vector, i.e., directly from three to one dimension.

Alternatively, one or more two-dimensional intermediate layers can also be provided, wherein the last intermediate layer is then converted into the vector.

Accordingly, in both cases explained above, the output variable of the pattern recognition module 36 is a vector in each case.

The further steps for determining the probable trajectories of the other road users 18, 20, 21 then proceed essentially as described in “Convolutional Social Pooling for Vehicle Trajectory Prediction” by N.Deo and MM Trivedi, arXiv:1805.06771.

The trajectory detection module 38 determines the previous trajectories of the other road users 18, 20, 21, wherein the output variable of the trajectory detection module 38 is also a vector.

The output vectors of the pattern recognition module 36 and of the trajectory recognition module 38 are linked to one another and transferred to the trajectory determination module 40.

Based on the linked output vectors of the pattern recognition module 36 and the trajectory recognition module 38, the trajectory determination module 40 determines the probable trajectory for each of the other road users 18, 20, 21, i.e., also for each other road user 20, 21 of a group separately.

The probable trajectory can be a family of trajectories. In other words, different possible trajectories together with their probabilities can be determined for each of the other road users 18, 20, 21.

The determined probable trajectories are then transferred to a driving maneuver planning module of the motor vehicle 10 or of the control unit 30.

Expressed in general terms, the driving maneuver planning module determines a driving maneuver to be carried out by the motor vehicle 10 based on the probable trajectories and based on the environmental data. In this case, an interaction of the motor vehicle 10 with the other road users 18, 20, 21 is taken into consideration via the probable trajectories of the other road users 18, 20, 21.

The driving maneuver to be carried out is then transferred to a trajectory planning module of the motor vehicle 10 or the control unit 30. Based on the received driving maneuver, the trajectory planning module determines the specific trajectory that the motor vehicle 10 is to follow.

Finally, based on the determined trajectory, the motor vehicle can be controlled at least partially automatically, in particular fully automatically.

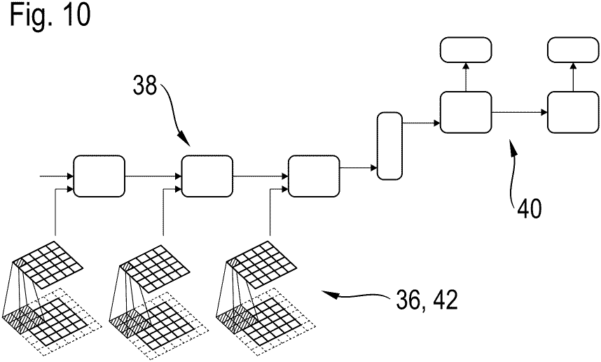

In FIG. 10, an alternative embodiment of the computer program of FIG. 7 is shown.

Here, the individual time strips of the three-dimensional tensor are each processed in the pattern recognition module 36 by means of a two-dimensional filter kernel, as a result of which a two-dimensional matrix is generated as the output variable in each case.

In other words, only one time strip is processed at a time.

The two-dimensional filter kernels can each have the same weighting factors for the different time strips.

The two-dimensional matrices are each converted into a vector and linked to a corresponding state vector hᵢ of the trajectory detection module 38, wherein hᵢ is the state vector for the time strip i.

The linked vectors are here the input variables for a feedback neural network (FNN) of the trajectory detection module 38, wherein the output variable of the feedback neural network are used as the input variable for the next feedback neural network or, in the case of the last feedback neural network, represents the output variable of the trajectory detection module 38.

The output of the trajectory detection module 38 is transferred to the trajectory determination module 40, which then determines the probable trajectories of the other road users 18, 20, 21, for example by means of at least one other feedback neural network.

1. A method for controlling a motor vehicle (10) driving on a road (12) in a current lane (14), wherein the motor vehicle (10) has at least one sensor (28) which is designed to acquire at least one area of the current lane (14) lying in front of the motor vehicle (10), and wherein at least one other road user (18, 20, 21) is on the current lane (14) and/or on at least one other lane (16), having the following steps:
acquiring environmental data by means of the at least one sensor (28), wherein the environmental data comprise items of information about properties of the current lane (14), about properties of the at least one other lane (16), and/or about the at least one other road user (18, 20, 21);
determining at least one utility value functional based on the environmental data, wherein the utility value functional assigns a utility value for the at least one other road user (18, 20, 21) at a predefined point in time to each of different spatial areas of the current lane (14) and/or the at least one other lane (16);
determining a two-dimensional representation of the at least one utility value functional; and
determining at least one probable trajectory of the at least one other road user (18, 20, 21) based on the two-dimensional representation of the utility value functional by applying pattern recognition to the two-dimensional representation.

2. The method as claimed in claim 1, wherein a two-dimensional representation of the corresponding utility value functional is determined at multiple predefined points in time, in particular in the past, and wherein the at least one probable trajectory of the at least one other road user (18, 20, 21) is determined based on the two-dimensional representations by applying pattern recognition to the two-dimensional representations.

3. The method as claimed in claim 2, wherein a three-dimensional tensor is determined based on the two-dimensional representations, and the at least one probable trajectory of the at least one other road user (18, 20, 21) is determined based on the tensor by applying pattern recognition to the tensor, wherein in particular the two-dimensional representations are stacked on one another along the time dimension to determine the tensor.

4. The method as claimed in claim 1, wherein that the different spatial areas are represented as grid points, and/or in that the two-dimensional representation is a two-dimensional image, in particular wherein a color of the individual pixels is determined based on the value of the corresponding utility value.

5. The method as claimed in claim 1, wherein the pattern recognition is carried out by means of an artificial neural network (42), in particular by means of a convolutional neural network, wherein in particular the artificial neural network (42) has two-dimensional and/or three-dimensional filter kernels and/or that the artificial neural network has two-dimensional or three-dimensional pooling layers.

6. The method as claimed in claim 1, wherein other road users (20, 21) who are spatially within a predefined distance from one another are regarded as a group of other road users (20, 21), wherein a common utility value functional is determined for the group of other road users (20, 21).

7. The method as claimed in claim 1, wherein, in particular for each other road user (18, 20, 21) in the group, a previous trajectory of the at least one other road user (18, 20, 21) is determined, wherein the at least one probable trajectory of the at least one other road user (18, 20, 21) is determined on the basis of the determined previous trajectory, in particular wherein the result of the pattern recognition and the previous trajectory are supplied to an artificial neural network which determines the at least one probable trajectory.

8. The method as claimed in claim 1, wherein the items of information about the properties of the current lane (14) and/or about the properties of the at least one other lane (16) can comprise at least one of the following elements: location and/or course of roadway markings, type of roadway markings, location and/or type of traffic signs, location and/or course of guide rails, location and/or switching status of at least one traffic light, location of at least one parked vehicle.

9. The method as claimed in claim 1, wherein the items of information about the at least one other road user (18, 20, 21) comprise a location of the at least one other road user (18, 20, 21), a speed of the at least one other road user (18, 20, 21), and/or an acceleration of the at least one other road user (18, 20, 21).

10. The method as claimed in claim 1, wherein the at least one probable trajectory is transferred to a driving maneuver planning module of the motor vehicle (10).

11. A control unit for a system (26) for controlling a motor vehicle (10) or for a motor vehicle (10), wherein the control unit (30) is designed to carry out a method as claimed in claim 1.

12. A computer program having program code means to carry out the steps of a method as claimed in claim 1 when the computer program is executed on a computer or a corresponding processing unit.
